(19) United States
(12) Patent Application Publication
(10) Pub. No.: US 2012/0155912 A1
(43) Pub. Date: Jun. 21, 2012

(54) FIXING DEVICE AND IMAGE FORMING APPARATUS

(75) Inventors: Toru Hayase, Toyohashi-shi (JP); Naoki Yamamoto, Toyohashi-shi (JP); Noboru Yonekawa, Toyohashi-shi (JP); Mamoru Fukaya, Nagoya-shi (JP)

(73) Assignee: Konica Minolta Business Technologies, Inc., Chiyoda-ku (JP)

(21) Appl. No.: 13/329,742

(22) Filed: Dec. 19, 2011

(30) Foreign Application Priority Data
Dec. 20, 2010 (JP) 2010-282690
Feb. 10, 2011 (JP) 2011-026919
Feb. 21, 2011 (JP) 2011-034477

(51) Int. Cl. G03G 15/20

(52) U.S. Cl. 399/90; 399/329

(57) ABSTRACT

A fixing device for fixing an unfixed image formed on a sheet by passing the sheet through a fixing nip, the fixing device comprising: a pair of ring-shaped electrodes each disposed along a different one of edges of endless belt and flanking a sheet-passing region on an external circumferential surface of the belt; and a pair of power feeders each being in contact with a different one of the ring-shaped electrodes at a contact area and feeding power to a resistive heat layer included in the belt, at least one of the power feeders being located at a position upstream from the fixing nip in a rotation direction of the belt and allowing a portion of the belt between the fixing nip and the contact area to be in close contact with the first roller while the belt is being rotated.

This application is based on applications No. 2011-34477, No. 2010-282690 and No. 2011-26919 filed in Japan, the content of which is hereby incorporated by reference.

### BACKGROUND OF THE INVENTION

(1) Field of the Invention

The present invention relates to a fixing device and an image forming apparatus having the fixing device. In particular, the present invention relates to a technology applicable to a fixing device to extend the life of a fixing belt, the fixing belt being included in the fixing device and having a resistive heat layer and electrode layers for feeding power to the resistive heat layer.

(2) Description of Related Art

As disclosed in Japanese patent application publication No. 2009-109997 for example, some image forming apparatuses such as printers proposed in recent years employ a fixing device that uses a fixing belt including a resistive heat layer. Such a fixing device provides an advantage of energy savings over a fixing device employing a halogen heater as a heat source.

FIG. 10 is a schematic perspective view showing the structure of such a fixing device, namely a fixing device 500.

As shown in the drawing, the fixing device 500 includes, for example, a fixing belt 554, a pressure roller 550, a pressing roller 560 and a pair of power feeding rollers 570 connected to an AC power source.

The fixing belt 554 is an elastically deformable belt having a cylindrical shape and including a resistive heat layer 554b. An electrode 554e is formed along the external circumferential surface of each widthwise edge portion (each edge portion in the Y-axis direction) of the resistive heat layer 554b.

With regard to the pressure roller 550, the surface of the shaft 551 is covered with an elastic layer 552. The pressure roller 550 is loosely inserted inside the running path of the fixing belt 554.

The pressing roller 560 is provided outside the running path of the fixing belt 554. The pressing roller 560 presses against the pressure roller 550 via the fixing belt 554, and forms a fixing nip 530.

The pressing roller 560 is rotated by driving force from a driving motor (not depicted), in the direction indicated by the arrow P in the drawing. The driving force is transmitted to the pressure roller 550 via the fixing belt 554. Accordingly, the fixing belt 554 and the pressure roller 550 are rotated together in the direction indicated by the arrow Q in the drawing.

The pair of power feeding rollers 570 is provided outside the running path of the fixing belt 554 and has contact with the pair of electrodes 554e of the fixing belt 554 such that each power feeding roller 570 presses against the corresponding electrode 554e in the downward direction in the drawing. Thus, the resistive heat layer 554b of the fixing belt 554 is provided with electrical power.

In the structure described above, when the electrodes 554e are supplied with electrical power via the power feeding roller 570 while the fixing belt 554 is being rotated, the electrical resistance of the electrodes 554e is much smaller than the resistive heat layer 554b, and the voltage drop of the electrodes 554e is negligibly small. Hence, electrical current flows all across the electrodes 554e in the circumferential direction, and then flows across the entirety of the resistive heat layer 554b in the Y-axis direction, which causes the resistive heat layer 554b to generate heat.

Note that since the direction of the flow of the current I regularly alternates, FIG. 10 shows the direction of the flow of the current I at a certain instant.

Here, since the fixing belt 554 has contact only with the fixing nip 530 and the power feeding roller 570 at the portions pressed thereby, the heat loss from the fixing belt 554 is limited. Hence, the temperature of the fixing nip 530 is effectively raised by Joule heating. A toner image formed on a recording sheet (not depicted) is applied with heat and pressure when it passes through the fixing nip 530, and is thermally fixed onto the recording sheet.

However, when the pressing roller 560 is rotated while being pressed against the pressure roller 550 via the fixing belt 554, the fixing belt 554 is deformed into an elliptical shape. Furthermore, due to, for example, the friction between the fixing belt 554 and the power feeding roller 570, the state of the fixing belt 554 running will be unstable. This leads to variations in the running path of the flexural portion of the fixing belt 554 (this phenomenon is hereinafter called “waving”).

FIG. 11A and FIG. 11B show the waving of the fixing belt 554, which is slightly exaggerated in the drawings.

As shown in FIG. 11A, the power feeding roller 570 is usually biased toward the pressure roller 550 by a compression spring 571 or the likes. When crossing over a convexity 554a of the flexural portion, the power feeding roller 570 is flipped up away from the pressure roller 550, and then moves back to the original position. However, if the power feeding roller 570 delays in following the fixing belt 554, a gap S occurs between the power feeding roller 570 and the fixing belt 554, as shown in FIG. 11B.

If this is the case, a spark discharge occurs in the gap S due to the potential difference between the power feeding roller 570 and the fixing belt 554, which could make a small hole in the surface of the fixing belt 554 and shorten the lifetime of the fixing belt 554. This is problematic.

### SUMMARY OF THE INVENTION

The present invention is made in view of the problem described above. The present invention aims to extend the lifetime of a fixing belt in a resistance-heating fixing device and an image forming apparatus, wherein the fixing belt is provided with a resistive heat layer and electrodes for supplying power to the resistive heat layer, and a pressure roller is loosely inserted inside the running path of the fixing belt.

To fulfill the aim, a first aspect of the present invention provides a fixing device for fixing an unfixed image formed on a sheet by passing the sheet through a fixing nip, the fixing device (i) forming the fixing nip by pressing with a second roller against a first roller loosely inserted inside a running path of an endless belt including a resistive heat layer, with the belt interposed between the first roller and the second roller, and (ii) causing the resistive heat layer to generate heat while the belt is being rotated, and thereby applying heat to the sheet passing through the fixing nip to fix the unfixed image, the fixing device comprising: a pair of ring-shaped electrodes each disposed along a different one of edges of the belt and flanking a sheet-passing region on an external circumferential surface of the belt; and a pair of power feeders each being in contact with a different one of the ring-shaped electrodes at a contact area and feeding power to the resistive heat layer, at least one of the power feeders being located at a position upstream from the fixing nip in a rotation direction of the belt and allowing a portion of the belt between the fixing nip and the contact area to be in close contact with the first roller while the belt is being rotated.

To fulfill the aim, a second aspect of the present invention provides an image forming apparatus having a fixing device for fixing an unfixed image formed on a sheet by passing the sheet through a fixing nip, the fixing device (i) forming the fixing nip by pressing with a second roller against a first roller loosely inserted inside a running path of an endless belt including a resistive heat layer, with the belt interposed between the first roller and the second roller, and (ii) causing the resistive heat layer to generate heat while the belt is being rotated, and thereby applying heat to the sheet passing through the fixing nip to fix the unfixed image, the fixing device comprising: a pair of ring-shaped electrodes each disposed along a different one of edges of the belt and flanking a sheet-passing region on an external circumferential surface of the belt; and a pair of power feeders each being in contact with a different one of the ring-shaped electrodes at a contact area and feeding power to the resistive heat layer, at least one of the power feeders being located at a position upstream from the fixing nip in a rotation direction of the belt and allowing a portion of the belt between the fixing nip and the contact area to be in close contact with the first roller while the belt is being rotated.

### BRIEF DESCRIPTION OF THE DRAWINGS

These and other objects, advantages and features of the invention will become apparent from the following description thereof taken in conjunction with the accompanying drawings that illustrate a specific embodiment of the invention.

In the drawings:

FIG. 1 is a schematic view illustrating the structure of a tandem-type color printer as an example of an image forming apparatus provided with a fixing device pertaining to an embodiment of the present invention;

FIG. 2 is a partially broken perspective view showing the structure of the fixing device;

FIG. 3 is a cross-sectional view showing a layer structure of a fixing belt of the fixing device;

FIG. 4 is a cross-sectional view of the fixing device;

FIG. 5 shows the running state of the fixing belt when a power feeder is provided downstream from a fixing nip N in the running direction of the fixing belt;

FIG. 6 shows a running state of the fixing belt at a certain instance when the location of the power feeder is moved further downstream;

FIG. 7 shows the change rate of the resistance between the electrode layer and the power feeder during the driving of the belt when the location of the power feeder of the fixing belt is changed;

FIG. 8 shows a cross section of the fixing device in a plane including a roller shaft thereof;

FIG. 9 is a cross-sectional view in which an area around a brush of the power feeder is enlarged;

FIG. 10 is a perspective view of a fixing device included in a conventional image forming apparatus; and

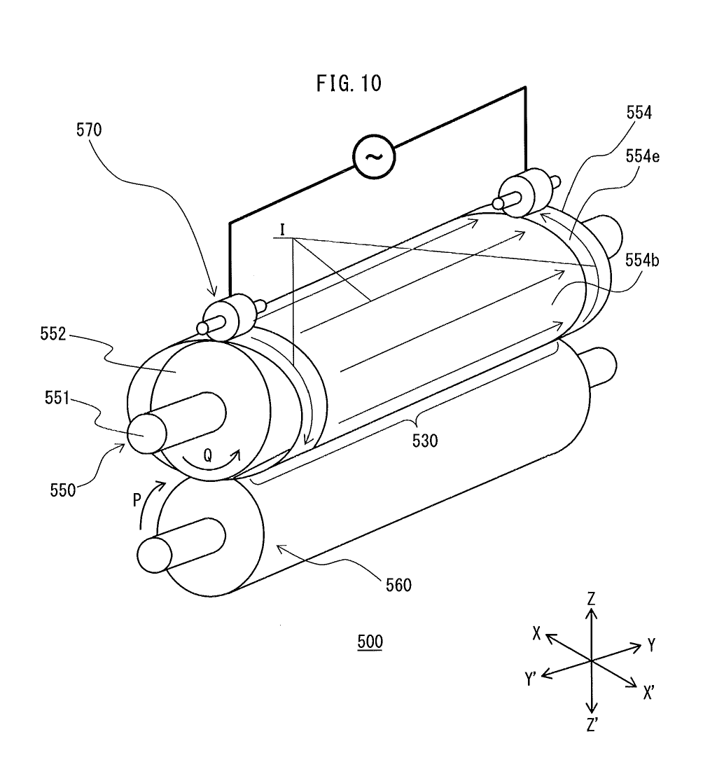

FIG. 11A and FIG. 11B show that the running path of the flexural portion of the fixing belt in a conventional fixing device changes.

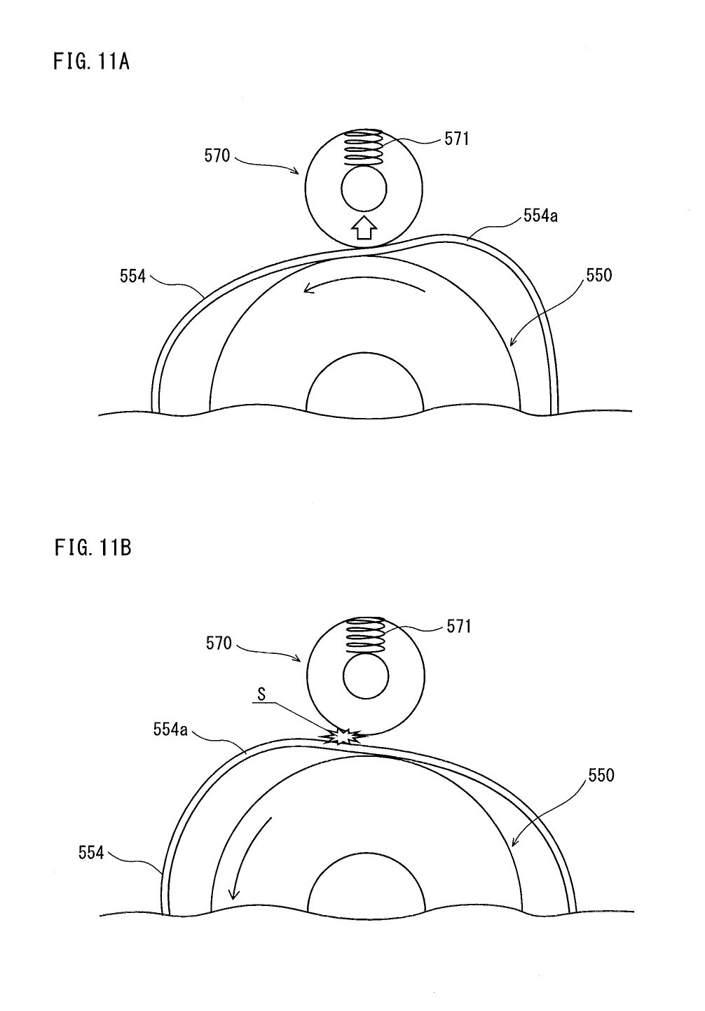

### DESCRIPTION OF PREFERRED EMBODIMENTS

The following describes an embodiment of a fixing device and image forming apparatus pertaining to the present invention, with reference to the drawings.

### <Structure of Image Forming Apparatus>

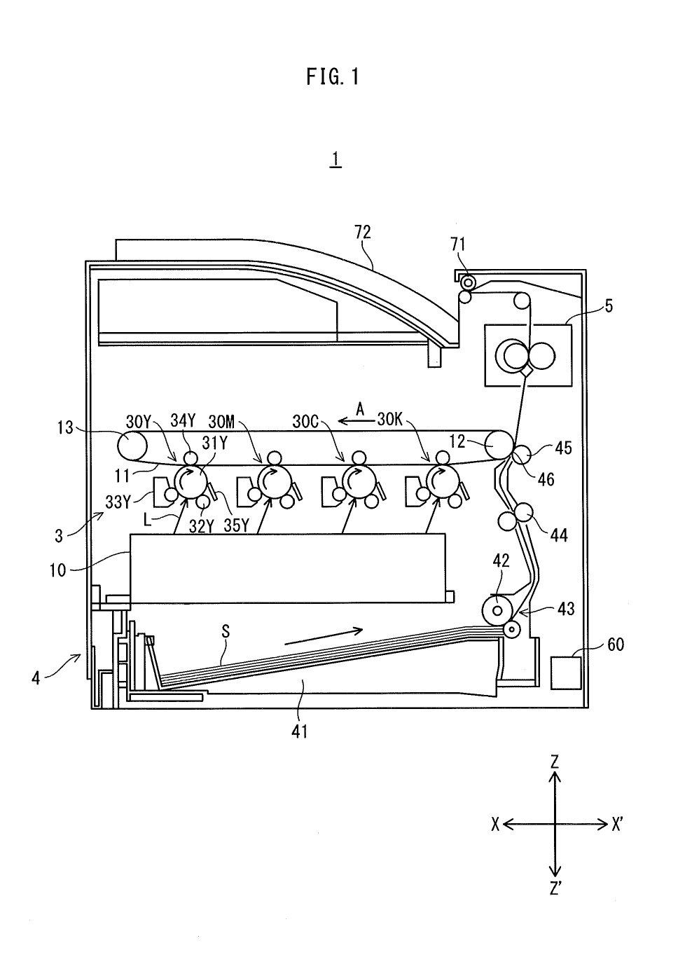

FIG. 1 is a schematic view illustrating the structure of a tandem-type color printer (hereinafter, simply “printer”) as an example of an image forming apparatus provided with a fixing device pertaining to an embodiment of the present invention.

As shown in the drawing, the printer 1 includes an image processor 3, a sheet feeder 4, a fixing unit 5, and a controller 60. The printer 1 may be connected to a network (such as LAN) to receive instructions for executing a print job from an external terminal device (not depicted). Upon receipt of such an instruction, the printer 1 forms toner images of the respective colors of yellow, magenta, cyan, and black, and sequentially transfers the toner images to form a full-color image.

In the following description, the reproduction colors of yellow, magenta, cyan, and black are denoted as “Y”, “M”, “C” and “K”, respectively, and any structural component related to one of the reproduction colors is denoted by a reference sign attached with an appropriate subscript “Y”, “M”, “C” or “K”.

### <Image Processor>

The image processor 3 includes image creating units 30Y, 30M, 30C, and 30K respectively corresponding to the colors Y, M, C, and K, and also includes an optical unit 10 and an intermediate transfer belt 11.

The image creating unit 30Y includes a photoconductive drum 31Y and also includes a charger 32Y, a developer 33Y, a first transfer roller 34Y, and a cleaner 35Y, which are disposed about the photoconductive drum 31Y. The cleaner 35Y is provided for cleaning the photoconductive drum 31Y. The image creating unit 30Y forms a yellow toner image on the photoconductive drum 31Y. The other image creating units 30M-30K each include the same components as the image creating unit 30Y. In the drawing, the reference numbers of the components of the other image creating unit are omitted.

The intermediate transfer belt 11 is an endless belt wound around a drive roller 12 and a passive roller 13 in taut condition to rotatably run in the direction indicated by the arrow A.

The optical unit 10 includes a light emitting element, such as a laser diode. In accordance with drive signals from the controller 60, the optical unit 10 emits a laser beam L to sequentially scan the surfaces of the photoconductive drums 31Y-31K to form images of the respective colors Y, M, C, and K.

Then, the electrostatic latent images are sequentially developed by the respective developers 33Y-33K to form toner images of colors Y-K on the photoconductive drum 31Y-31K with appropriately adjusted timing. As a result, the process of first transfer is carried out to layer the transferred images on precisely the same position on the surface of the intermediate transfer belt 11.

By the action of the electrostatic force imposed by the first transfer rollers 34Y-34K, the toner images of the respective colors are sequentially transferred onto the intermediate transfer belt 11 to form a full color toner image, which is then carried to a second transfer position 46 by the intermediate transfer belt 11.

The sheet feeder 4 includes: a paper feed cassette 41 for storing recording sheets S; a pickup roller 42 that picks up a recording sheet S from the paper feed cassette 41 one sheet at a time and feeds the recording sheet S onto a transport path 43; and a pair of timing rollers 44 that adjusts the timing to transport the fed recording sheet S to a second transfer position 46. The recording sheet S is fed from the sheet feeder 4 to the second transfer position 46 in synchronization with the movement of toner images on the intermediate transfer belt 11. As a secondary transfer roller 45 operates, toner images on the intermediate transfer belt 11 are secondarily transferred onto the recording sheet S together.

The recording sheet S having passed through the second transfer position 46 is transported to the fixing unit 5 where heat and pressure is applied to the recording sheet S, so that the toner image (unfixed image) on the recording sheet S is fused and fixed. The recording sheet S then passes between a pair of ejection rollers 71 to be ejected onto an exit tray 72.

### <Structure of Fixing Unit>

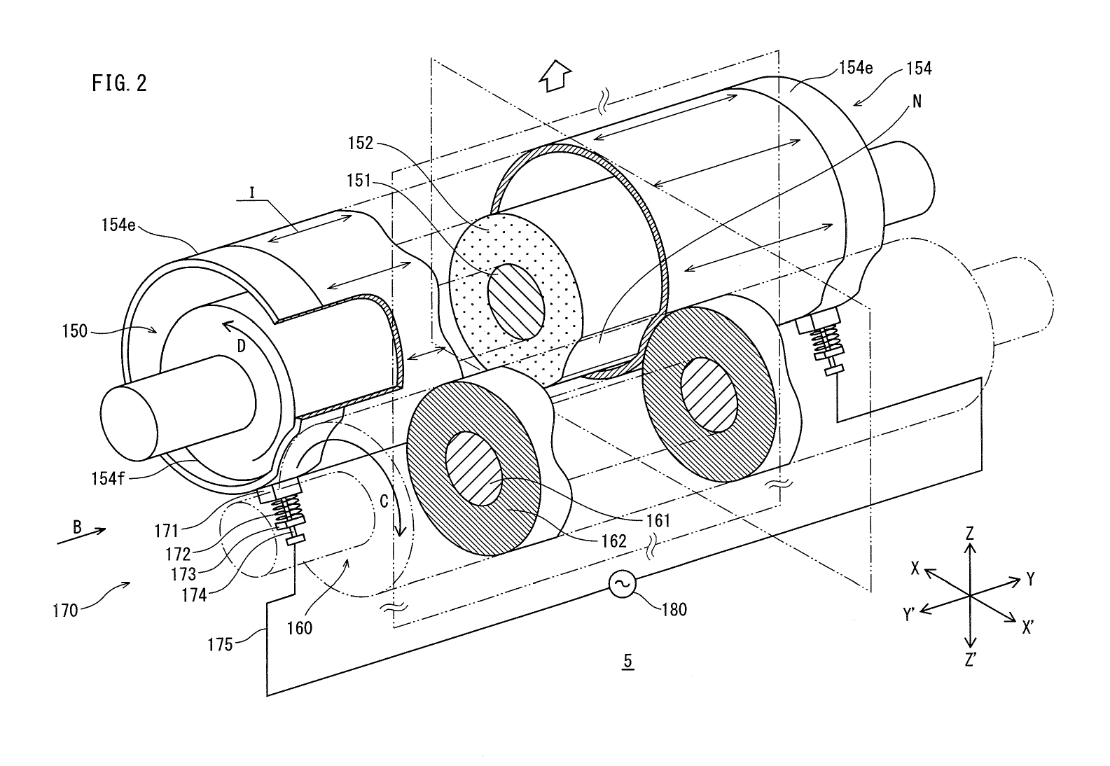

FIG. 2 is a partially broken perspective view showing the structure of the fixing unit 5.

As shown in the drawing, the fixing unit 5 includes a fixing belt 154, a pressure roller 150, a pressing roller 160 and power feeders 170.

The pressure roller 150 is loosely inserted in the fixing belt 154, and the pressure roller 150 and the pressing roller 160 are disposed in parallel. The pressing roller 160 presses the pressure roller 150 via the fixing belt 154, by using a biasing mechanism (not depicted). As a result, a fixing nip is formed between the fixing belt 154 and the pressing roller 160. The toner image formed on the recording sheet S is applied with heat and pressure and is fixed while the recording sheet S passes through the fixing nip.

The following describes the structure of each component of the fixing unit 5 in detail.

### <Structure of Pressing Roller>

The pressing roller 160 is rotated by a driving mechanism (not depicted) in the direction indicated by the arrow C, and presses the pressure roller 150 via the fixing belt 154, from the outside surface of the fixing belt 154.

The fixing belt 154 and the pressure roller 150 are therefor rotated together in the direction indicated by the arrow D.

As shown in FIG. 2, the pressing roller 160 includes a shaft 161 and an elastic layer 162 coating the surface of the shaft 161 except for the edge portions thereof.

The shaft 161 is rotated by a driving mechanism (not depicted), and is a solid shaft made of, for example, aluminum, iron, or stainless, and having an outer diameter of approximately 30 mm.

As an alternative to such a solid shaft, a hollow shaft having a thickness of approximately 0.1 mm to 10 mm, or a hollow shaft with a reinforcement rib that has a Y-shaped cross-section and is provided in the hollow may be used.

The elastic layer 162 is a cylindrical member made of silicone rubber, and it is preferable that the thickness of the elastic layer 162 is no less than 1 mm and no greater than 20 mm.

In the present embodiment, the thickness of the elastic layer 162 is set to 3 mm and the outer diameter is set to 36 mm.

The length of the elastic layer 162 in the Y-axis direction is 374 mm.

### <Pressure Roller>

As shown in FIG. 2, the pressure roller 150 has a structure in which the circumferential surface of the shaft 151 having an elongated cylindrical shape is coated with the elastic layer 152.

The shaft 151 is a solid shaft made of, for example, aluminum, iron, or stainless, and having an outer diameter of approximately 20 mm. Both edges thereof in the shaft direction are received in bearings that are provided on the main frame (not shown) of the fixing unit 5.

As an alternative to such a solid shaft, a hollow shaft having a thickness of approximately 0.1 mm to 10 mm, or a hollow shaft with a reinforcement rib that has a Y-shaped cross-section and is provided in the hollow may be used.

The elastic layer 152 is made of a highly heat-resisting and heat-insulating foamed elastic material, such as a silicone rubber or a fluorine-containing rubber. The thickness of the elastic layer 152 is in the range from 1 mm to 20 mm. Thus the outer diameter of the pressure roller 150 falls within the range from 20 mm to 100 mm. In the present example, the outer diameter of the pressure roller 150 is 30 mm.

The length of the elastic layer 152 in the Y-axis direction is 374 mm.

The length of the elastic layer 152 in the Y-axis direction is of course set to be greater than the maximum paper width of the recording sheet S.

The degree of hardness of the elastic layer 152 is lower than the elastic layer 162 of the pressing roller 160. Mainly the elastic layer 152 is elastically deformed at the fixing nip N.

### <Fixing Belt>

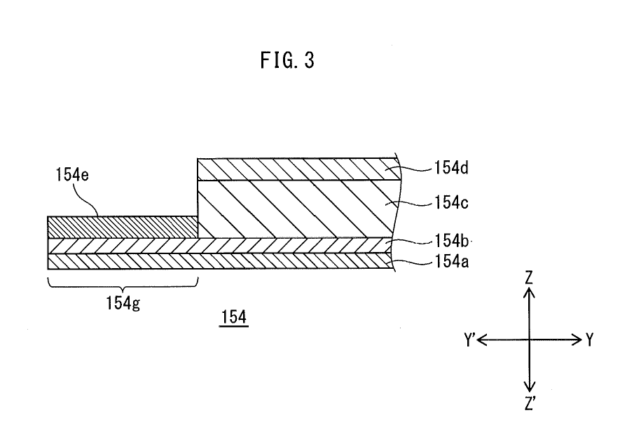

FIG. 3 is a partial cross-sectional view showing a layer structure of the fixing belt 51.

Although the figure only focuses on one end of the fixing belt 51 in the roller shaft direction, the other end of the fixing belt 51 has the same structure.

Also, although the thickness in the drawing is slightly exaggerated to facilitate understanding of the structure, the dimensions of the components in the drawing do not necessarily coincide with the dimensions described below.

The fixing belt 154 is an elastically deformable endless belt having a layered structure. As shown in the drawing, a resistive heat layer 154b is layered on the external circumferential surface of an insulative layer 154a. Also, an electrode layer 154e is layered on each edge in the Y-axis direction of the external circumferential surface of the resistive heat layer 154b.

Furthermore, an elastic layer 154c and a releasing layer 154d are layered in this order on the portions of the external circumferential surface of the resistive heat layer 154b where are not coated with the electrode layer 154e.

The following describes each of the layers constituting the fixing belt 154 in detail.

The insulative layer 154a is made of a non-conductive material, such as polyimide (PI), polyphenylenesulfide (PPS), or polyether ether ketone (PEEK). The thickness of the insulative layer 154a is approximately 50 μm, and the length thereof in the Y-axis direction is set to 374 mm.

The resistive heat layer 154b is a cylindrical heat generating element that generates heat due to Joule heating responsive to electric current flowing through in the Y-axis direction, which is caused by the potential difference across both edges thereof in the Y-axis direction.

More specifically, the thickness of the resistive heat layer 154b is in the range from 5 μm to 100 μm. The resistive heat layer 154b is formed, for example, by evenly dispersing one or more conductive fillers mutually different in electrical resistance, in a polyimide (PI) resin.

The length of the resistive heat layer 154b in the Y-axis direction is set to 374 mm, which is the same as the length of the insulative layer 154a.

As a base material for forming the resistive heat layer 154b, other materials such as PPS and PEEK may be used.

Preferable examples of the conductive fillers include: metal powder, such as Ag, Cu, Al, Mg and Ni; carbon-based powder materials, such as graphite, carbon black, carbon nanofiber and carbon nanotube; and high-ion conductive materials, such as silver iodide and copper iodide, present in inorganic compounds. Preferably, the electrically conductive fillers are in a fibrous state to ensure that the conductive fillers to make more contact per unit content.

In the present embodiment, a fibrous conductive filler, such as Ni, is evenly dispersed in the base material described above.

It is preferable that the volume resistance of the resistive heat layer 154b falls within the range from 1.0×10̂−6 to 1.0×10̂−2 Ω·m. It is also preferable that the volume resistivity of the fixing unit 5 of the present embodiment falls within the range from 1.0×10̂−5 to 5.0×10̂−3 Ω·m.

The elastic layer 154c is made from, for example, an elastic and heat-resisting material such as silicone rubber and about 200 μm thick.

Alternatively to the silicone rubber, the elastic layer 154c may be made from, for example, a fluorine-containing rubber.

The releasing layer 154d is made from a material having releasability, typified by a fluorine-containing resin, such as PTFE or PFA, and its thickness is in the range from 5 μm to 100 μm.

The electrode layers 154e are respectively formed along both edges in the Y-axis direction of the resistive heat layer 154b, and serve as a pair of ring-shaped electrodes for supplying power to the resistive heat layer 154b.

The electrode layers 154e are made, for example, from a material with lower electrical resistance than the resistive heat layer 154b, such as Cu, Al, Ni, brass, or phosphor bronze, and are formed by chemically or electrically plating, with the material, the external circumferential surfaces of both edges of the resistive heat layer 154b.

Alternatively, a strip-shaped sheet as the electrode layer 154e made of the material described above may be bonded to both edges in the Y-axis direction of the resistive heat layer 154b by an adhesive having electrical conductivity.

The width (i.e. the length in the Y-axis direction) of the electrode layer 154e is 18 mm.

The thickness of the electrode layers 154e preferably falls within the rage from 5 μm to 100 μm, in order to secure an appropriate strength and a flexibility required for being responsive to the deformation of the belt, particular at the fixing nip N. In this example, the thickness is set to 20 μm.

### <Power Feeder>

Returning to FIG. 2, the power feeders 170 are electrically connected to an external AC power source 180 via a lead wire 175. The power feeders 170 are connected to the pair of electrode layers 154e of the fixing belt 154 such that the power feeders 170 are slidable on the surfaces of the electrode layers 154e, and thereby supply power to the electrode layers 154e.

The lead wire 175 is connected to the AC power source 180 via a relay switch (not depicted). The controller 60 powers ON and OFF the relay switch based on the surface temperature of the fixing belt 154 detected by a temperature sensor (not depicted) so that the temperature of the fixing belt 154 will be a predetermined target temperature.

The power feeder 170 includes a brush 171, an elastic member 172, a supporting plate 173 and a shaft 174.

The brush 171 is a conductive member having a block shape, and specifically is a carbon brush made of a material that is slidabale and conductive, such as copper-graphite or carbon-graphite. For example, the brush 171 has a thickness of 30 mm, a width of 10 mm in the Y-axis direction, and the length of 5 mm in the sliding direction.

The problem, namely the phenomenon that a large amount of current flows the electrode layers 154e and makes a hole, occurs not only when a discharge occurs between the power feeder 170 and the electrode layer 154e, but also when the contact area between them temporarily becomes extremely small and the current density increases locally.

As described above, a large current-carrying area can be secured by pressing the brush 171 having the block shape against the electrode layer 154e. This structure lowers the possibility that the contact area temporarily becomes extremely small even when the contact is unstable.

The shaft 174 is a electrically conductive shaft made of metal or the like. One end of the shaft 174 is embedded into the brush 171 and is thus fixed, and the other end is connected to the lead wire 175.

The supporting plate 173 is connected to the main frame of the fixing unit 5 and has a through hole (not depicted). The shaft 174 is slidably inserted in the through hole.

The elastic member 172 is a compression coil spring, for example. The elastic member 172 is inserted between the brush 171 and the supporting plate 173, and presses the brush 171 against the external circumferential surface of the electrode layer 154e, as shown in FIG. 2.

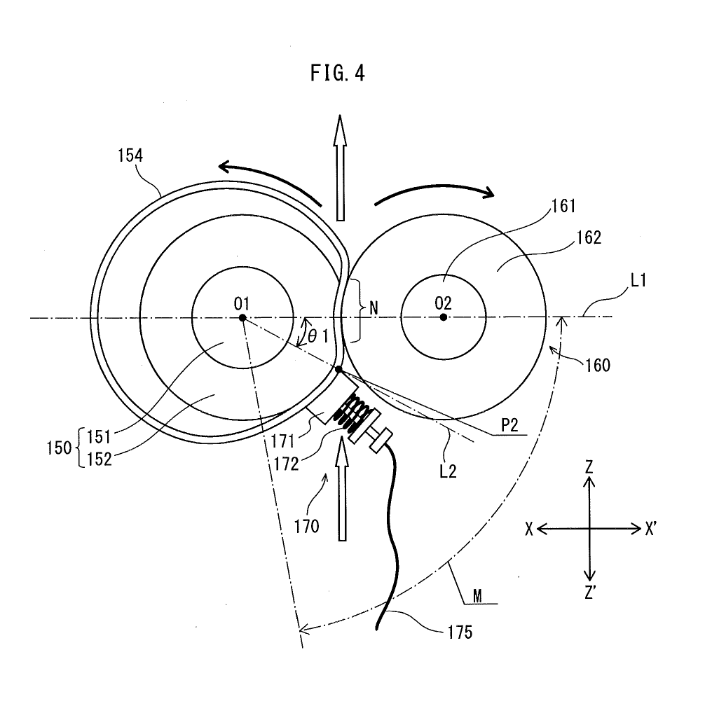

FIG. 4 shows the cross-section shown in FIG. 2 viewed in the Y direction, and particularly shows the location of the power feeder 170. Note that the hatching for showing the cross-section is intentionally omitted from this drawing, in order to simplify the drawing.

As shown in FIG. 4, the power feeder 170 is disposed upstream from the fixing nip N in the running direction of the fixing belt 154. In addition, the power feeder 170 is disposed within the range M. Here, the central angle corresponding to the range M, which is an angle of a line L2 with respect to a line L1 in the reverse direction of the circumferential direction of the fixing belt 154 (hereinafter “belt circumferential direction”), is no greater than 80°. The line L1 is a straight line passing through the rotation center O1 and the rotation center O2 of the pressure roller 150 and the pressing roller 160, respectively. The line L2 is a straight line connecting an edge P2 of a contact area between the power feeder 170 and the fixing belt 154 with the rotation center O1 of the pressure roller 150. The edge P2 is closer to the fixing nip N of the power feeder 170 than the opposite edge in the belt circumferential direction.

Here, an angle of a line L2 with respect to a line L2, which is formed upstream from the fixing nip N in the rotation direction of the fixing belt 154 is defined as an angle θ1.

The following describes the above-described effective location of the power feeder 170.

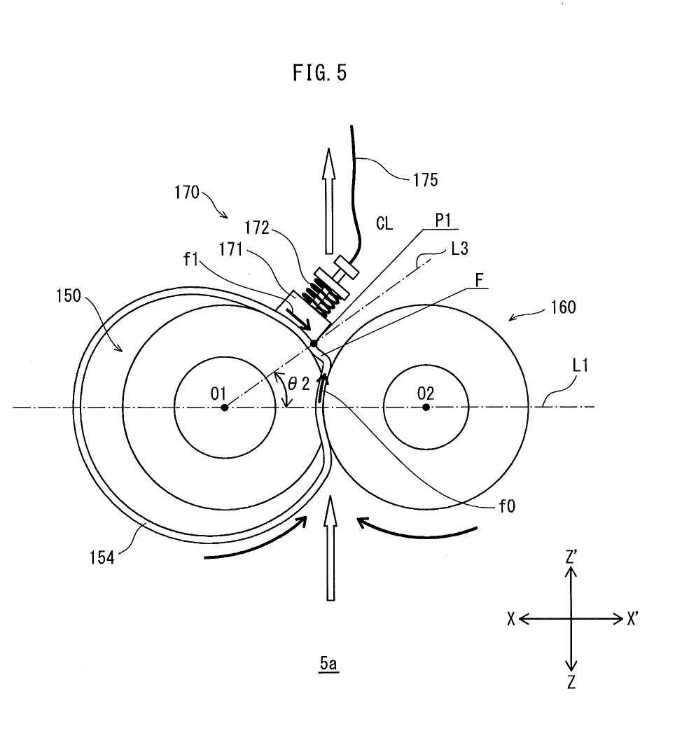

The inventors of the present invention observed the running state of the fixing belt 154 in the structure shown in FIG. 5. Specifically: the power feeder 170 is downstream from the fixing nip N in the rotation direction of the fixing belt 154; and the angle θ2 formed by the line L1 and the line L3 is approximately 50°. The line L1 is a straight line passing through the rotation centers O1 and O2 of the pressure roller 150 and the pressing roller 160, respectively. The line L3 is a straight line passing through the edge P1 of the contact area between the power feeder 170 and the fixing belt 154, and the rotation center O1 of the pressure roller 150. The edge P1 is closer to the fixing nip N than the opposite edge in the circumferential direction of the fixing belt 154.

The drawing shows the running state of the fixing belt 154 in this case.

In this structure, a frictional force f1 caused between the fixing belt 154 and the power feeder 170 acts in the opposite direction as the force f0 which pushes the fixing belt 154 downstream in the rotation direction of the fixing belt 154. This can be a cause of a flexural portion F occurring near the fixing nip N, and leads to the waving of the fixing belt 154.

As a result, contact between the electrode layer 154e and the power feeder 170 will be unstable, and discharge easily occurs between them. This could shorten the lifetime of the fixing belt 154.

The condition will be similar to the conventional art when the angle θ2 is gradually increased. Specifically, the distance between the downstream edge of the fixing nip N and the contact area of the power feeder 170 increases, and the degree of flexure increases. This makes the running path of the fixing belt 154 unstable, and the waving becomes more likely to occur. Consequently, the contact state between the electrode layer 154e and the power feeder 170 becomes worse.

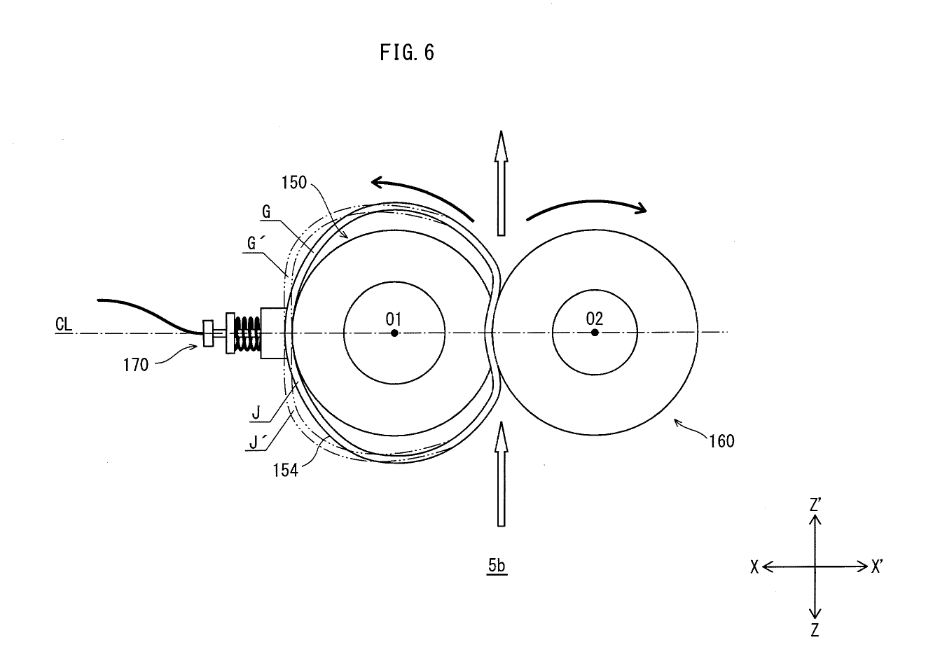

FIG. 6 shows the running state at a certain instance of the fixing belt 154 when the angle formed by the straight line CL passing through the center point of the contact area of the power feeder 170 with the fixing belt 154 in the belt circumference direction and the rotation center O1 of the pressure roller 150 and the straight line passing through the rotation center O1 and the rotation center O2 is 180°.

As shown in the drawing, flexural portions G and J exist at opposite positions on the fixing belt 154 with respect to the power feeder 170.

When the fixing belt 154 is rotated, the running paths of the flexural portions G and J are displaced as indicated by the signs G′ and J′. This can be considered as a cause of rendering contact between the electrode layer 154e and the power feeder 170 unstable.

In view of this, the inventors observed the running state of the fixing belt in the structure shown in FIG. 4. Specifically: the power feeder 170 is upstream from the fixing nip N in the rotation direction of the fixing belt 154; and the angle θ1 formed by the line L1 and the line L2 is approximately 50°. The line L1 is a straight line passing through the rotation centers O1 and O2 of the pressure roller 150 and the pressing roller 160, respectively. The line L2 is a straight line passing through the edge P2 of the contact area between the power feeder 170 and the fixing belt 154, and the rotation center O1 of the pressure roller 150. The edge P2 is closer to the fixing nip N than the opposite edge in the circumferential direction of the fixing belt 154.

With this structure, the portion of the fixing belt 154 between the fixing nip N and the contact area between the power feeder 170 and the fixing belt 154 was in close contact with the external circumferential surface of the pressure roller 150, and contact between the electrode layer 154e and the power feeder 170 was stable. Moreover, no discharge occurred between them.

It can be considered that this is for the following reasons. When the fixing belt 154 is pulled toward the fixing nip by the rotation of the pressure roller 150 and the pressing roller 160, tension is generated in the fixing belt 154 due to the frictional force caused by contact between the fixing belt 154 and the brush 171. Accordingly, the fixing belt 154 will be pressed against the circumferential surface of the pressure roller 150 and will be in close contact with the pressure roller 150. Therefore, the running path of the fixing belt 154 is stable between the fixing nip N and the contact position with the brush 171, and the waving does not occur. Thus, no gap occurs between the brush 171 and the electrode on the fixing belt 154, and spark discharge does not occur between them.

Considering the above, the inventors conducted tests for obtaining the maximum value of the angle θ1 with which contact between the electrode layer 154e and the power feeder 170 is stable.

In the tests, values R1 and R2 were measured with the angle θ1 changed, where R1 is the maximum resistance between the electrode layer 154e and the power feeder 170 when the fixing belt 154 is being rotated, and R2 is the resistance between the electrode layer 154e and the power feeder 170 when the fixing belt 154 is stopped.

Then, the change rate H (%) of the resistance (hereinafter “resistance change rate”) between the electrode layer 154e and the power feeder 170 were obtained by substituting the measured values R1 and R2 into Equation 2 shown below.

H=(R1−R2)/R2×100 Equation 2

Here, when the resistance change rate H (%) is small, it means that contact between the electrode layer 154e and the power feeder 170 is stable, and vice versa.

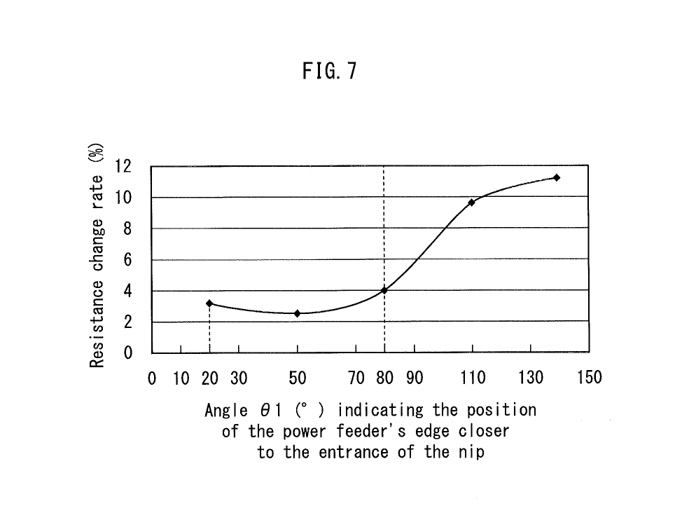

FIG. 7 shows the results of the tests.

The fixing device used in the tests was basically the same as the fixing unit 5 in the present embodiment, and only the location of the power feeder was changed.

As shown in the drawing, when the angle θ1 is in the range from 20° to 80, the resistance change rate H % is a low value, which falls within the range from 2% to 4%. This indicates that contact between the electrode layer 154e and the power feeder 170 is stable.

In contrast, when the θ1 exceeds 80°, the resistance change rate H (%) increases sharply, and contact between the electrode layer 154e and the power feeder 170 will be unstable.

It can be considered that this is for the following reasons. When the angle θ1 is not greater than 80°, the force of pulling the belt is dominant at the nip N, and since the distance between the external circumferential surface of the pressure roller 150 and the internal circumferential surface of the fixing belt 154 is originally short, the close contact between the pressure roller 150 and the fixing belt 154 can be easily maintained even though the pressure by the power feeder is not applied. On the other hand, when the angle θ1 is within the range from 80° to 170°, the distance between the external circumferential surface of the pressure roller 150 and the internal circumferential surface of the fixing belt 154 becomes even longer if the pressure by the power feeder is not applied. In addition, due to the significant effect of the flexural portion generated upstream therefrom, the fixing belt 154 easily moves away from the surface of the pressure roller 150.

For the reasons described above, when the angle θ1 is in the range from 20° to 80°, contact between the fixing belt 154 and the pressure roller 150 is kept stable in the area from the position where the power feeder 170 is in contact with the fixing belt 154 to the position of the fixing nip N. Consequently, contact between the electrode layer 154e and the power feeder 170 will be stable, and this extends the lifetime of the fixing belt 154.

Moreover, as shown in the drawing, the resistance change rate H is at the lowest when the angle θ1 is 50°, and varies only a little with in the range of around 50°. It is therefore preferable that the angle θ1 falls within the range from 30° to 60°, inclusive.

Here, as can be seen from the drawing, the resistance change rate H increases as the angle θ1 decreases from 50° and approaches 20°. It can be assumed that this is due to the effect of the deformation of the nip N.

Note that the power feeder 170 is upstream from the fixing nip N in the rotation direction of the fixing belt 154, and the graph does not show data when the angle θ1 is smaller than 20°. This is because the power feeder 170 interferes with the fixing nip N when the angle θ1 is smaller than 20°.

### <Modifications>

The present invention is not limited to the embodiment described above. The following modifications may be adopted.

(1) In the embodiment described above, the fixing belt 154 includes the insulative layer 154a, the resistive heat layer 154b, the elastic layer 154c, the releasing layer 154d and the electrode layers 154e. However, such a structure is not essential. The fixing belt 154 may have a different structure as long as it includes the resistive heat layer 154b and the electrode layers 154e.

For example, in the case of a monochrome copier, the fixing nip may be smaller in width without adversely affecting the fixing quality much, as compared with the case of a color copier. For this reason, the fixing belt 154 for a monochrome copier may be configured without the elastic layer 154c.

(2) In the embodiment described above, each power feeder 170 is provided with the block-shaped brush 171 that is in contact with the electrode layer 154e of the fixing belt 154. Alternatively, however, each power feeder 170 may be provided with a metal roller instead of the brush 171 according to the situation, in order to keep electric contact with the electrode layer 154c.

It can be considered that the use of a metal roller reduces the friction with the fixing belt 154, and thereby reduces the tension generated in the portion of the fixing belt 154 that is between the contact position between the power feeder 170 and the fixing belt 154 and the position of the fixing nip N.

The tension would contribute to stabilizing the contact between the electrode layer 154e and the power feeder 170 by bringing the metal roller into close contact with the pressure roller 150. If there is a demand for keeping the tension, it is preferable to increase the friction by attaching a leaf spring to the shaft of the metal roller.

(3) In the embodiment described above, the pressing roller 160 is rotated, and the pressure roller 150 is driven by the pressing roller 160. This structure, however, is not essential.

For example, the pressure roller 150 may be rotated and the pressing roller 160 be driven by the pressure roller 150. Alternatively, both the pressure roller 150 and the pressing roller 160 may be rotated.

(4) In the embodiment described above, the degree of hardness of the elastic layer 152 of the pressure roller 150 is set to be lower than the elastic layer 162 of the pressing roller 160, and mainly the elastic layer 152 at the fixing nip N is elastically deformed. Such a structure, however, is not essential. The degree of hardness of the elastic layer 152 may be higher than the elastic layer 162 or the same as the elastic layer 162, as long as the fixing quality is not degraded.

(5) In the embodiment described above, the brush 171 of each power feeder 170 has a block shape. The brush 171, however, may have the shape as described below.

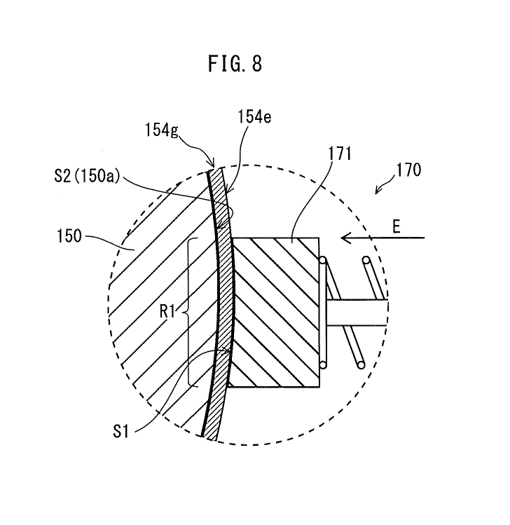

FIG. 8 is a cross-sectional view in which an area around the brush 171 of the power feeder 170 is enlarged.

The contact area S1 of the brush 171, which slides over the electrode layer 154e, is formed to fit to the external circumferential surface 150a of the pressure roller 150, with the fixing belt 154 therebetween. Specifically, the cross-section of the contact area S1 of the brush 171 is formed to have the shape of an arc that is concentric with the cross-section of the external circumferential surface 150a of the pressure roller 150, considering the thickness of the edge portion 154g of the fixing belt 154 where the electrode layer 154e is provided.

With this structure, when the edge portion 154g is sandwiched between the contact area S1 and the external circumferential surface 150a of the pressure roller 150 while the contact area S1 of the brush 171 is biased by the elastic member 172 toward the edge 154g of the fixing belt 154, no gap occurs between the contact area S1 and the edge portion 154g of the fixing belt 154, and between the external circumferential surface 150a and the area R1 in which the fixing belt 154 is pressed by the contact area S1 of the brush 171.

In this structure, a contact area S2 is formed, which is a contact area where part of the external circumferential surface 150a of the pressure roller 150 is in contact with the fixing belt 154. The contact area S1 of the brush 171 is smaller than the contact area S2, and the contact area S1 is completely included in the contact area S2 when viewed in the biasing direction E.

This is for the following reason. When the brush 171 is pressed against the fixing belt 154, the stated structure allows not only the area R1, which is pressed by the contact area S1 of the brush 171, but also the area surrounding the area R1, which is elastically deformed inward, to be in contact with the external circumferential surface 150a of the pressure roller 150.

As described above, the fixing belt 154 is supported at the area S2 of the pressure roller 150 which is larger than the area R1. Hence, the fixing belt 154 can not be deformed inward within the contact area, and the surface pressure (contact pressure) due to the biasing force applied by the power feeder 170 will be greater than a given value across the entire contact area of the power feeder 170.

With the stated structure, even when foreign objects, such as paper dust of recording sheets and abrasion powder of the parts, adhere to or are accumulated on the surface of the fixing belt 154, the fixing belt 154 is prevented from being partially deformed inward. Thus, the stated structure prevents foreign objects from entering into the gap formed between the power feeder 170 and the fixing belt 154.

The foreign objects are mainly removed from the fixing belt 154 by the edge portion on the front side of the power feeder 170 (i.e. the intersection between the upstream edge surface of the power feeder 170 in the rotation direction of the fixing belt 154 and the contact area S1), or are accumulated on the edge portion.

(6) In the embodiment above, the width of the brush 171 in the Y-axis direction is narrower than the width of the electrode layer 154e. This, however, is not essential, and the width of the brush 171 may be wider than the electrode layer 154e.

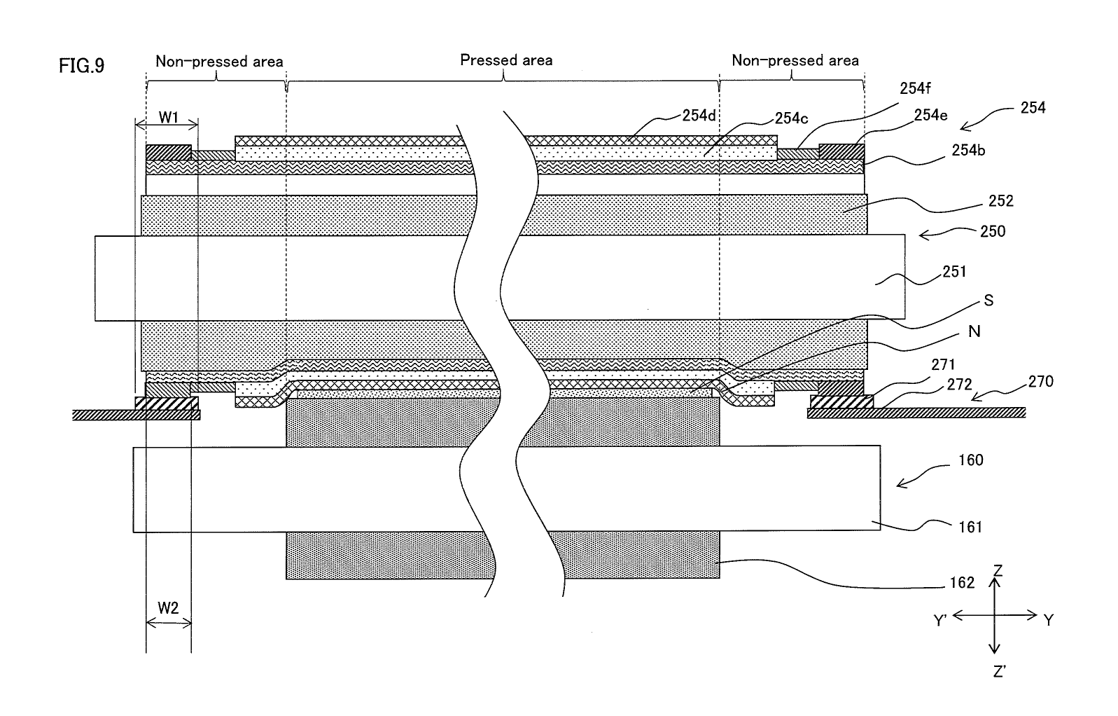

FIG. 9 is a schematic cross-sectional view of a fixing device pertaining to a modification of the present invention having the structure described above, when viewed in the rotation direction of the pressing roller 160.

In the drawing, the pressure roller 150 and the fixing belt 154 are depicted as a pressure roller 250 and a fixing belt 254 each extended in the Y-axis direction.

The fixing belt 254 is an elastically deformable endless belt having a layered structure.

As shown in the drawing, an elastic layer 254c and a releasing layer 254d are layered in this order on the external circumferential surface of the resistive heat layer 254b of the fixing belt 254, except for both edge portions of the external circumferential surface of the resistive heat layer 254b. On both edge portions, a electrode layer 254e and an insulative layer 254f are layered such that the insulative layer 254f is closer to the elastic layer 254c.

Both edges of the elastic layer 254c and the releasing layer 254d are located at a predetermined distance from the inside edge of the corresponding electrode layer 254e in order to prevent interference with the power feeder 270.

The electrode layers 254e are respectively formed along both edges in the Y-axis direction of the resistive heat layer 254b, and serve as a pair of ring-shaped electrodes for supplying power to the resistive heat layer 254b.

With regard to the brush 271 of the power feeder 270 of the present modification, the width W1 in the Y-axis direction is set to be greater than the width W2 of the electrode layer 254e in the Y-axis direction. Also, in the contact area between the power feeder 270 and the electrode layer 254e, the location of the power feeder 270 with respect to the Y-axis direction is determined such that the entire width (in the Y-axis direction) of the electrode layer 254e is in contact with the power feeder 270.

With the stated structure, the brush 271 is in contact with the electrode layer 254e along the entire width (in the Y-axis direction) of the electrode layer 254e, and the stress applied to the electrode layer 254e and the deformation of the electrode layer 254e due to the contact will be uniform in the Y-axis direction. Thus, in contrast to conventional structures in which the brush is partially in contact with the electrode layer in the Y-axis direction, the electrode layer 254e will not be easily peeled off, because the stress and the deformation will hardly be concentrated at any particular point. This considerably improves the durability of the electrode layer 254e, and extends the lifetime of the fixing belt 254.

The insulative layer 254f is thinner than the electrode layer 254e. The insulative layer 254f is adjacent to the electrode layer 254e, and is disposed to coat the resistive heat layer 254b on the external circumferential surface of the fixing belt 254.

With the stated structure, the brush 271 is prevented from overlapping the insulative layer 254f and causing poor contact with the electrode layer 254e. Also, since power is directly fed by the brush 271 to the resistive heat layer 254b, there is no risk of generation of abnormal heat at a power feeding point.

(7) The embodiment is described above based on the case where the image forming apparatus pertaining to the present invention is adopted in a tandem-type color digital printer. However, the present invention is applicable to monochrome printers, for example. In other words, the present invention is generally applicable to resistance-heating fixing device and an image forming apparatus having the fixing device, wherein a fixing belt thereof is provided with a resistive heat layer and electrode layers for supplying power to the resistive heat layer, and a pressure roller is loosely inserted inside the running path of the fixing belt.

In addition, the embodiment and the modifications may be combined in a reasonable manner.

Although the present invention has been fully described by way of examples with reference to the accompanying drawings, it is to be noted that various changes and modifications will be apparent to those skilled in the art.

Therefore, unless such changes and modifications depart from the scope of the present invention, they should be construed as being included therein.

What is claimed is:

1. A fixing device for fixing an unfixed image formed on a sheet by passing the sheet through a fixing nip, the fixing device (i) forming the fixing nip by pressing with a second roller against a first roller loosely inserted inside a running path of an endless belt including a resistive heat layer, with the belt interposed between the first roller and the second roller, and (ii) causing the resistive heat layer to generate heat while the belt is being rotated, and thereby applying heat to the sheet passing through the fixing nip to fix the unfixed image, the fixing device comprising:
a pair of ring-shaped electrodes each disposed along a different one of edges of the belt and flanking a sheet-passing region on an external circumferential surface of the belt; and
a pair of power feeders each being in contact with a different one of the ring-shaped electrodes at a contact area and feeding power to the resistive heat layer, at least one of the power feeders being located at a position upstream from the fixing nip in a rotation direction of the belt and allowing a portion of the belt between the fixing nip and the contact area to be in close contact with the first roller while the belt is being rotated.

2. The fixing device of claim 1, wherein
each power feeder is disposed so that an angle of a first line with respect to a second line is not greater than 80° in a reverse direction of the rotation direction, where the first line is a line connecting a center point of the first roller with a center point of the second roller, and the second line is a line connecting an edge of the contact area of the power feeder in the rotation direction with a center point of the first roller, the edge being closer to the fixing nip than the opposite edge of the contact area in the rotation direction.

3. The fixing device of claim 2, wherein
the angle is from 30° to 60° inclusive.

4. The fixing device of claim 2, wherein
each power feeder is block-shaped.

5. The fixing device of claim 1, wherein
a surface of each power feeder facing the corresponding one of the ring-shaped electrodes has a greater width than the corresponding one of the ring-shaped electrodes in a rotation axis direction of the belt.

6. The fixing device of claim 5, wherein
a non-heat-generating layer is disposed on the external circumferential surface of the belt within an area sandwiched between the ring-shaped electrodes, and each edge of the non-heat-generating layer in the rotation axis direction is located at a distance from an inside edge of the corresponding ring-shaped electrode.

7. The fixing device of claim 6, wherein
an area between the edge of the non-heat-generating layer and the inside edge of the corresponding ring-shaped electrode is coated with an insulative layer having a smaller thickness than the ring-shaped electrode.

8. The fixing device of claim 1, wherein
a cross-section of the contact area of each power feeder in a plane perpendicular to a rotation axis direction of the belt coincides with a cross-section in the same plane of a contact area of the first roller with the belt, and the contact area of each power feeder is included within the contact area of the first roller when viewed in a direction of the pressing against the first roller.

9. An image forming apparatus having a fixing device for fixing an unfixed image formed on a sheet by passing the sheet through a fixing nip, the fixing device (i) forming the fixing nip by pressing with a second roller against a first roller loosely inserted inside a running path of an endless belt including a resistive heat layer, with the belt interposed between the first roller and the second roller, and (ii) causing the resistive heat layer to generate heat while the belt is being rotated, and thereby applying heat to the sheet passing through the fixing nip to fix the unfixed image, the fixing device comprising:
a pair of ring-shaped electrodes each disposed along a different one of edges of the belt and flanking a sheet-passing region on an external circumferential surface of the belt; and
a pair of power feeders each being in contact with a different one of the ring-shaped electrodes at a contact area and feeding power to the resistive heat layer, at least one of the power feeders being located at a position upstream from the fixing nip in a rotation direction of the belt and allowing a portion of the belt between the fixing nip and the contact area to be in close contact with the first roller while the belt is being rotated.
